(19) United States
(12) Patent Application Publication
(10) Pub. No.: US 2006/0078228 A1
(43) Pub. Date: Apr. 13, 2006

(54) Information processing device and program

(75) Inventor: Mashiro Tsutaki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignees: Kabushiki Kaisha Toshiba; Toshiba Solutions Corporation

(21) Appl. No.: 11/245,140

(22) Filed: Oct. 7, 2005

(30) Foreign Application Priority Data
Oct. 8, 2004 (JP) P2004-296955

(51) Int. Cl. G06K 9/32

(52) U.S. Cl. 382/298

(57) ABSTRACT

An information processing device includes an input screen information storage unit 11 which stores input screen information configured to correlate at least an input screen identifier, with an input field identifier, and with a first display size and a second display size, a primary screen data generation unit 15 which generates input screen data by reading the input screen information corresponding to the input screen identifier specifying the input screen subject to a display instruction out of the input screen information storage unit 11 and allocating the first display size to the character display limit value of each input field, a secondary screen data generation unit 16 which generates input screen data when an arbitrary input field is focused by changing the character display limit value corresponding to the input field identifier of the focused input field from the first display size into the second display size, and an input screen display unit 18 which displays an input screen.

### BACKGROUND OF THE INVENTION

1. Field of the Invention

The present invention relates to an information processing device and a program having a function to provide a variable display size of an input field on a screen in which characters are typed in by a user operation through an input device.

2. Description of the Related Art

In general, an Information Processing Device configured to display characters on a display device and the like, and display characters inputted by an operator through an input device are used in many fields.

For example, an operator who receives questions from customers often makes reference to or registers data by use of character display and input functions on a input screen while talking with customers and operating a computer, in a call center where operators correspond to customers by phone.

In this case, it is favorable in light of operating efficiency to consolidate all necessary pieces of information on a single input screen. However, there are limitations in the size and resolution of the screen displayed on the display device to consolidate all the necessary pieces of information on the single input screen. For this reason, each size of character input fields for respective items are inevitably confined.

Size of a input field is fixed, so far. Therefore, if more characters are inputted than the size of an input field, the Information Processing Device cannot display all the characters inputted by the operator. In this case, the operator has to scroll the characters since when reading the characters, they are not displayed in the input field.

Meanwhile, when displaying the information like characters on a fixed size input field, there is a technique to improve legibility of characters on a screen by offering a simple operation to enlarge or reduce a character scale (see Japanese Unexamined Patent Publications No. 5(1993)-324636 and No. 6(1994)-266706, for example). Meanwhile, there is also a technique to improve visibility of information such as characters or images by enlarging a window as well as enlarging the character scale (see Japanese Unexamined Patent Publication No. 10(1998)-154061, for example). Moreover, there is a technique to offer user-oriented operation and to improve visibility of displayed information by changing the density and the size of the information depending on the size of a defined area (see Japanese Patent Publication No. 7(1995)-31498, for example).

According to the above-technique, operators do not need to scroll, when enlarging or reducing a character scale in the fixed display size input field. But, it is difficult for operators to read the reduced characters. When it is difficult for operators to read characters, responsibility for operation increases, and a decrease in efficiency of operation occurs.

### SUMMARY OF THE INVENTION

In consideration of the foregoing problems, it is an object of the present invention to provide an information processing device and a program, which allows an operator to easily execute operations such as a character input operation easily and to change field sizes.

To attain the object, an aspect of the present invention provides an information processing device to change the size of a input field to a fixed size or to a specified size by the operator, when an input field on input screen was focused. Focusing the input field on the input screen is the transaction to move a cursor on the input field and operate to allow an input character in the input field, when the operator can input the characters by the input device like a keyboard. At that time, operators can read all the characters inputted on the input field at first sight. The efficiency of operation like inputting characters by operators improves for this reason.

Meanwhile, another aspect of the present invention provides an information processing device, enabling to set a maximum display size or a minimum display size, whether the input field is in focus or out of focus. For this reason, operators can accordingly set the display size of the input field freely. The operator sets the display size of the input field to maximum display size, when the operator wants to display all the characters inputted. On the other hand, the operator sets the display size of the input field to minimum display size, when the operator wants to display minimum characters inputted.

Moreover, an aspect of the modified example of the present invention provides an information processing device, enabling to set a block that includes some input fields, and enables to set the display size of the input fields by the block to maximum display size or minimum display size. For this reason, operators can accordingly set the display size of the input field included in the block freely.

### BRIEF DESCRIPTION OF THE DRAWINGS

FIG. 1 is a view for hardware of the information processing device according to the embodiment of the present invention.

FIG. 2 is a block diagram of an information processing device according to an embodiment of the present invention.

FIG. 3 is a view showing an example of display information to be stored in the information processing device according to the embodiment of the present invention.

FIG. 4 is a view showing an example of input information to be stored in the information processing device according to the embodiment of the present invention.

FIG. 5 is a view showing an example of a setting table to be stored to execute a program according to the embodiment of the present invention.

FIG. 6 is a view showing an example of an input screen to be displayed by the program according to the embodiment of the present invention.

FIG. 7 is a flowchart of processing by the information processing device according to the embodiment of the present invention.

FIG. 8 is a view showing an example of the input screen to be displayed by the program according to the embodiment of the present invention.

FIG. 9 is a view showing another example of the input screen to be displayed by the program according to the embodiment of the present invention.

FIG. 10 is a view showing another example of the input screen to be displayed by the program according to the embodiment of the present invention.

FIG. 11 is a view showing an example of an input screen of processing for changing a display size to be displayed by a program according to a first modified example of the embodiment of the present invention.

FIG. 12 is a view showing another example of the input screen of processing for changing the display size to be displayed by the program according to the first modified example of the embodiment of the present invention.

FIG. 13 is a view showing an example of display information in the case where it is possible to change the display size to be displayed by the program according to the first modified example of the embodiment of the present invention.

FIG. 14 is a view showing another example of the display information in the case where it is possible to change the display size to be displayed by the program according to the first modified example of the embodiment of the present invention.

FIG. 15 is a view showing an example of a history table to be stored by executing a program according to a second modified example of the embodiment of the present invention.

FIG. 16 is a view showing an example of input information to be stored in the information processing device according to a third modified example of the embodiment of the present invention.

FIG. 17 is a view showing an example of a setting table to be stored to execute the program according to the third modified example of the embodiment of the present invention.

FIG. 18 is a view showing an example of an input screen to be displayed by the program according to the third modified example of the embodiment of the present invention.

FIG. 19 is a view showing an example of a setting table to be stored to execute a program according to a fourth modified example of the embodiment of the present invention.

FIG. 20 is a view showing an input screen to be displayed by the program according to the fourth modified example of the embodiment of the present invention.

### DETAILED DESCRIPTION OF THE INVENTION

An embodiment of the present invention will be described with reference to the accompanying drawings.

An information processing device according to the embodiment of the present invention is constructed by installing a program according to the embodiment of the present invention on an information processing device by an operator. This program is implemented by use of the hyper text markup language (HTML), JavaScript(registered trademark), for example.

(Information Processing Device)

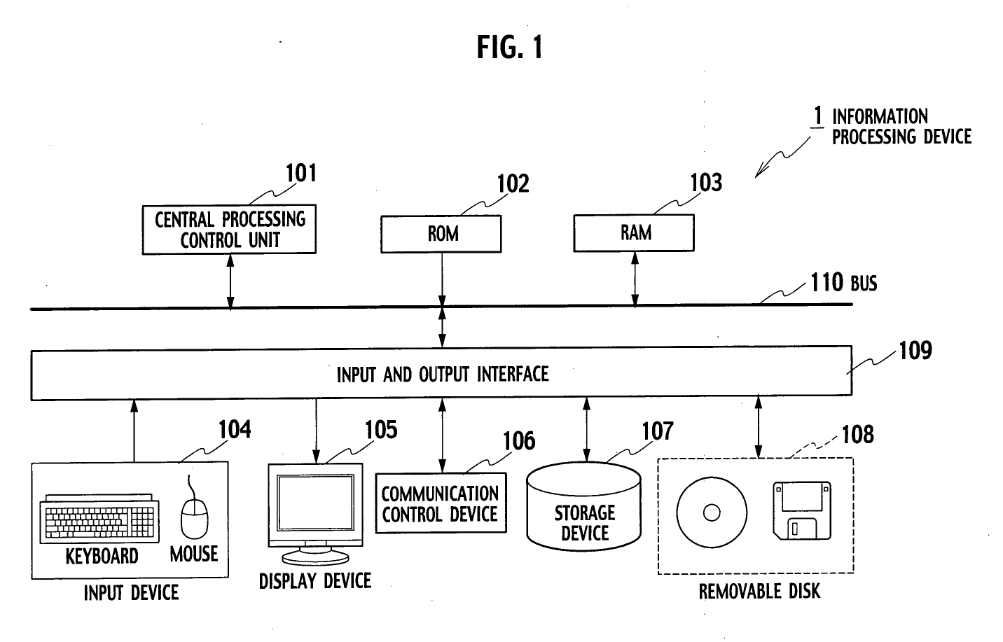

As shown in FIG. 1, the information processing device 1 according to the embodiment of the present invention includes a central processing control unit 101, a read only memory (ROM) 102, a random access memory (RAM) 103, and an input and output interface 109, all of which are connected to one another through a bus 110. Meanwhile, an input device 104, a display device 105, a communication control device 106, a storage device 107, and a removable disk 108 are connected to the input and output interface 109.

The central processing control unit 101 reads and executes a boot program for starting the information processing device 1 out of the ROM 102 based on an input signal from the input device 104, and then reads an operating system stored in the storage device 107. Further, the central processing control unit 101 is the processing device which is configured to control the respective devices based on input signals from the input device 104, the communication control device 106, and the like, to read programs and data stored in the storage device 107, and the like and to load the programs and the data into the RAM 103, and to realize a series of processing to be described later, including data calculation and data processing, based on commands of the program read out of the RAM 103.

The input device 104 includes an input device such as a keyboard or a mouse for allowing the operator to input various operations such as inputting characters. The input device 104 generates input signals based on the operations by the operator, and transmits the input signals to the central processing control unit 101 through the input and output interface 109 and the bus 110. The display device 105 is a cathode ray tube (CRT) display, a liquid crystal display or the like, which is the device configured to receive an output signal to be displayed on the display device 105 from the central processing control device 101 through the bus 110 and the input and output interface 109, and to display a processing result of the central processing control unit 101, for example. The communication control device 106 is a device such as a local area network (LAN) card or a modem, which is the device configured to connect the information processing device 1 to a communication network such as the Internet or a LAN. Data transmitted to or received from the communication network through the communication control device 106 are transmitted to or received by the central processing control device 101 through the input and output interface 109 and the bus 110 as input signals or as output signals.

The storage device 107 is a semiconductor storage device, a magnetic disk device or the like, which is configured to store the program and the data to be executed by the central processing control unit 101. The removable disk 108 represents an optical disk or a flexible disk. Signals written in or read out by a disk drive are transmitted to or received from the central processing control unit 101 through the input and output interface 109 and the bus 110.

Note that the information processing device 1 according to the embodiment of the present invention may be realized either by a single computer or by a plurality of computers capable of communicating with one another.

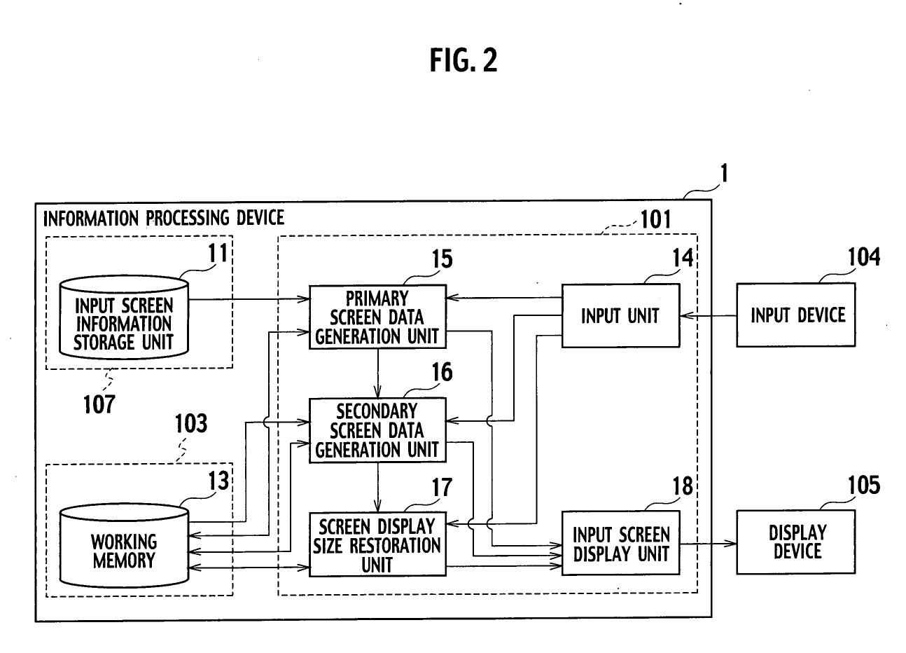

FIG. 2 is a block diagram showing an information processing device 1 according to the embodiment of the present invention. As shown in FIG. 2, the information processing device 1 according to the embodiment of the present invention includes an input screen information storage unit 11, a working memory 13, an input unit 14, a primary screen data generation unit 15, a secondary screen data generation unit 16, a screen display size restoration unit 17, and an input screen display unit 18.

The input screen information storage unit 11 corresponds to the storage device 107 shown in FIG. 1. The working memory 13 corresponds to the RAM 103 shown in FIG. 1. Meanwhile, the input unit 14, the primary screen data generation unit 15, the secondary screen data generation unit 16, the screen display size restoration unit 17, and the input screen display unit 18 are implemented as a result of reading and execution of the program according to the embodiment of the present invention by the central processing control unit 101 of the information processing device 1.

The input unit 14 is provided to allow the operator to input operating instructions such as the display request and to input the input information.

The input screen information storage unit 11 has stored the input screen information for generating the input screen display on the display device 105 as described previously. The “input screen”, include the input field display the input information inputted through the input unit 14.

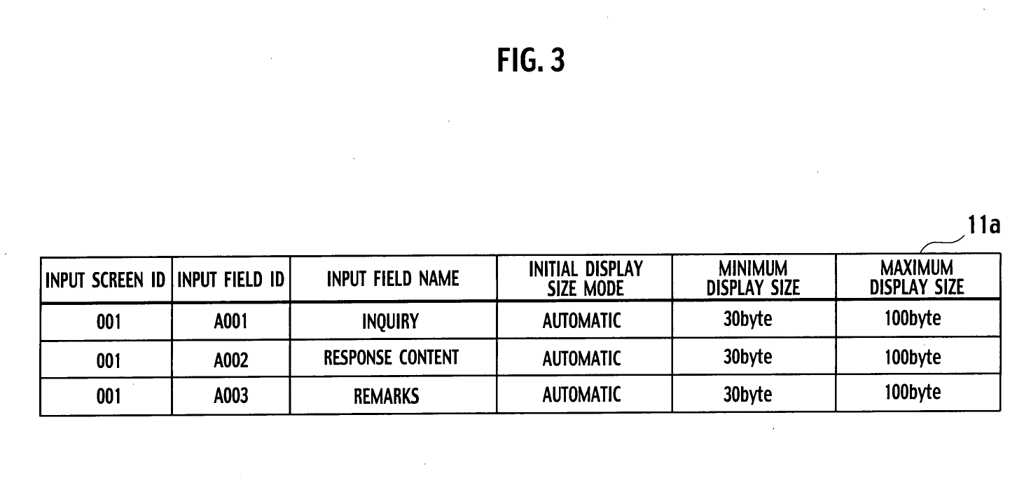

FIG. 3 is a view showing an example of the input screen information 11a to be stored in the input screen information storage unit 11. The input screen information 11a shown in FIG. 3, the “input field ID” used as a key correlated with the “input screen ID” to identify an input screen, allocate this input field, the “initial display size mode” of the input field, the “maximum display size” of the input field and the “minimum display size” of the input field.

The input screen information 11a shown in FIG. 3 includes the information on the “display size mode”, “maximum display size” and the “minimum display size” in terms of an “inquiry content input field”, a “response content input field”, and a “remarks input field”, respectively. The “maximum display size” and the “minimum display size” to be described later are the “character display limit value” established for each input field. An “initial display size mode” represents an initial display size mode of the input field specified by the input field ID when the primary input screen data are generated. The operator can change this display size mode freely by a later operation.

Here, the “maximum display size”, one of the “character display limit value” is a value of the maximum display size representing characters typed by the operator into the input field on the input screen with input device 104 such as a keyboard. The “character display limit value” applies the byte as the unit thereof. For example, when the “character display limit value” is equal to 50 double-byte characters (100 bytes), then even if the total characters actually typed into the input field is equal to 30 double-byte characters, the input field displays 50 double-byte characters (100 bytes) by adding 20 double-byte spaces (40 bytes) thereto.

The “minimum display size”, one of the “character display limit value” represents the minimum value of the character display limit value of the input field displayed on the input screen. Even if characters in excess of the number of characters determined by this “minimum display size” are inputted, the input screen does not display all the characters. Accordingly, a scrolling operation using the mouse or the like is required. Meanwhile, the “maximum display size” represents the maximum value of the character display limit value of the input field displayed on the input screen. Although these “minimum display size” and “maximum display size” have been described as the default values in the embodiment of the present invention, it is also possible to render these values editable by the operator when appropriate.

This input screen information 11a shown in FIG. 3 stores that the “minimum display size” of the “inquiry content input field” is equal to 30 bytes and that the “maximum display size” thereof is equal to 100 bytes. When the “inquiry content input field” is set to the “maximum display size”, the inquiry content input field is displayed in the size equal to 100 bytes.

Here, in terms of the input field having the initial display size mode set to the “automatic mode”, the display size thereof is automatically switched to the minimum display size or to the maximum display size depending on movement of the focus.

To be more precise, when the input field having the initial display size mode set to the “automatic mode” is focused, the display size of that input field is changed from the minimum display size to the maximum display size. “Focusing” is the transaction moving the cursor on the input field by the input device like a mouse, enabling the operator to input characters in the input field. Here it becomes possible to put in the characters on the input field.

Meanwhile, when the input field is out of focus, the display size of this input field is changed from the maximum display size to the minimum display size. “Out of focus” is the transaction moving the cursor off the input field by the input device like a mouse, disabling the operator to input characters in the input field. Here it becomes impossible to put in the characters on the input field.

Meanwhile, in terms of the input field having the initial display size mode set to the “fixed enlarged mode”, the display size thereof is set to the maximum display size constantly (to the default value). To be more precise, when the input field is set to the “fixed enlarged mode”, the display size of the input field there of is changed to the “maximum input field size”. Accordingly, this input field is always displayed in the enlarged size, whether this input field is focused or out of focus.

Moreover, in terms of the input field having the initial display size mode set to the “fixed reduced mode”, the display size thereof is set to the minimum display size constantly (to the default value). To be more precise, when the input field is set to the “fixed reduced mode”, the display size of the input field thereof is changed to the “minimum input field size”. Accordingly, this input field is always displayed in reduced size, whether this input field is focused or out of focus.

The primary screen data generation unit 15 reads the input screen information corresponding to the input screen ID for specifying the input screen data of the input screen subject to the display request from the input unit 14 out of the input screen information storage unit 11. The primary screen data generation unit 15 generates primary input screen data by allocating a first display size included in the input screen information thus read out to the character display limit value of each input field. Meanwhile, the primary screen data generation unit 15 writes the display size of each input field included in the input screen information read out of the input screen information storage unit 11 into a display size setting table 13a in the working memory 13.

The primary input screen data are generated by the primary screen data generation unit 15. Based on the primary input screen data, the display device displays a primary input screen which is an initial input screen.

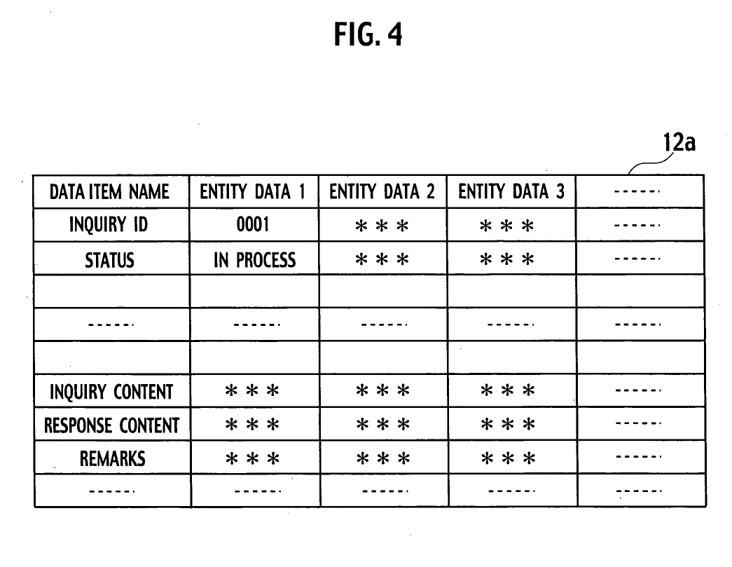

The working memory 13 temporarily stores information such as characters which are actually typed in the input field on the input screen by input device 104. For example, in terms of input information 12a shown in FIG. 4, the working memory 13 stores entity data including “0001” for an “inquiry ID” item, “in process” for a “status” item, “***” for an “inquiry content” item, “***” for a “response content” item, “***” for “remarks” item, and so forth.

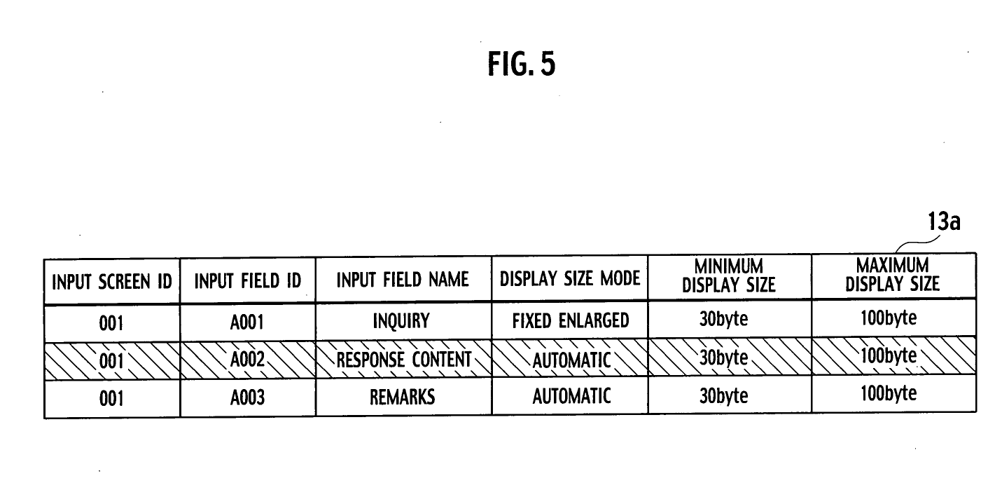

As shown in FIG. 5, the display size setting table 13a stored in the working memory 13 applies the “input field ID” as a key, and further includes items of the “display size mode”, the “minimum display size”, and the “maximum display size”, for example. The “display size mode” has substantially the same significance as the “initial display size mode” described in FIG. 3. When the display size mode is changed in accordance with an operation of the input unit 14 by the operator, the “display size mode” is equivalent to the display size mode reflecting the change. The “minimum display size” and the “maximum display size” have been described already by use of FIG. 3, and explanation thereof will be omitted herein.

The respective display sizes stored in the beginning in the display size setting table 13a are the same as the display sizes stored in the above-described input screen information 11a. Here, the “initial display size mode” stored in the input screen information 11a is stored herein as the “display size mode”. These respective display sizes can be changed by a later operation by the operator using the display device.

In the display size setting table 13a shown in FIG. 5, the “inquiry content input field” is set to the “fixed enlarged mode”, and the “response content input field” and the “remarks input field” are set to the “automatic mode”. The secondary screen data generation unit 16 generates an input screen data changing display size of the input field on the input screen which is generated by the primary screen data generation unit 15, based on the operating instruction inputted in the input unit 14 by the input device 104.

When an arbitrary input field in the input screen is focused based on an operating instruction inputted from the input unit 14 and a display size mode of the focused input field is set to an “automatic mode” to be described later for example, the secondary screen data generation unit 16 refers the display size setting table 13a in the working memory 13, and generates secondary input screen data by changing the character display limit value corresponding to input field ID of the focused input field into the maximum display size.

Here, the “display size mode” is one of attributes for input screen information given to the input field or a block to be described later.

(1) To be more precise, the display size mode includes the “automatic mode” configured to set the character display limit value to the maximum display size when the input field or the block is focused by the input device 104, and to set the display character limit value to the minimum display size when the input field or the block is out of focus.

(2) The display size mode also includes a “fixed enlarged size mode” configured to set the display size limit value constantly to the maximum display size when selected regardless of whether the input screen in focused or out of focused by the input device 104.

(3) Moreover, the display size mode includes a “fixed reduced mode” configured to set the display size limit value constantly to the minimum display size when selected regardless of whether the input screen is focused or out of focus by the input device 104. The details of these display size modes will be described later.

Moreover, when the display size mode of the input field selected by the operating instruction inputted from the input unit 14 is set to the “fixed enlarged mode”, for example, the secondary screen data generation unit 16 reads the display size setting table 13a in the working memory 13, and generates the secondary input screen data by changing the character display limit value corresponding to input field ID set to the fixed enlarged display mode into the maximum display size.

Furthermore, when the display size mode of the input field selected by the operating instruction inputted from the input unit 14 is set to the “fixed reduced mode”, the secondary screen data generation unit 16 reads the display size setting table 13a in the working memory 13, for example, and generates the secondary input screen data by changing the character display limit value corresponding to input field ID set to the fixed reduced display mode into the minimum display size.

The secondary input screen data is derived from the primary input screen data by the secondary screen data generation unit 16 based on the operating instruction inputted from the input unit 14. The display device 105 displays a secondary input screen based on the secondary input screen data while changing the size of the input field.

When the input field out of focus is displayed in the maximum display size under the setting the “automatic mode”, the screen display size restoration unit 17 refers the display size setting table 13a, and generates the input screen data by changing the character display limit value corresponding to this input field ID from the maximum display size into the minimum display size.

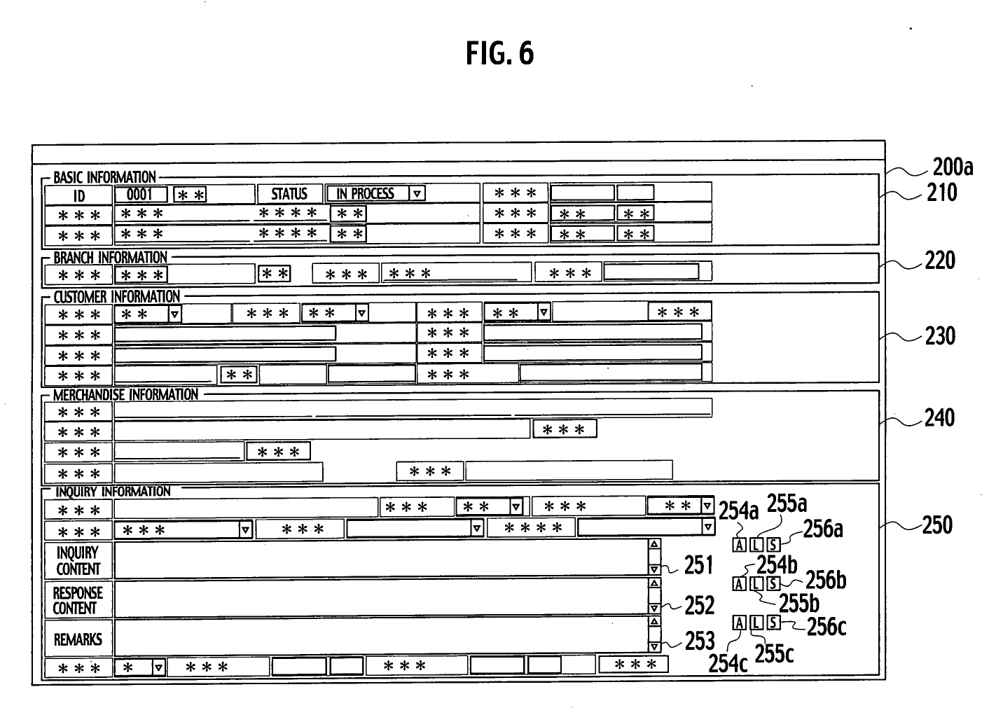

The input screen display unit 18 displays the primary input screen generated by the primary screen data generation unit 15 to the display device 105. Meanwhile, the input screen display unit 18 displays the input screen based either on the input screen data generated by the secondary screen data generation unit 16 or on the input screen data generated by the screen display size restoration unit 17 on the display device 105. FIG. 6 shows an example of an input screen 200a, which is the primary input screen to be displayed on the input device 105 by the information processing device 1 installing the program according to the embodiment of the present invention. The input screen 200a shown in FIG. 6 includes a plurality of blocks 210 to 250 representing “basic information”, “branch information”, “customer information”, “merchandise information”, and “inquiry information”, respectively. Each of the blocks 210 to 250 includes input fields and selection fields inside.

For example, the block 250 representing the “inquiry information” includes input fields 251 to 253, to which data concerning data items having the names of the “inquiry content”, the “response content”, and the “remarks” are inputted. The operator using the input screen 200a can select any one mode out of the “automatic mode”, the “fixed enlarged mode”, and the “fixed reduced mode” for each of the input fields 251 to 253 so as to change the sizes of the input fields 251 to 253.

For this reason, on the input screen 200a, automatic mode setting buttons 254a to 254c for setting the “automatic mode”, fixed enlarged mode setting buttons 255a to 255c for setting the “fixed enlarged mode”, and fixed reduced mode setting buttons 256a to 256c for setting the “fixed reduced mode” are displayed as shown in FIG. 6 so as to correspond to the input fields 251 to 253, respectively. Although the input screen 200a shown in FIG. 6 is the example of displaying the respective setting buttons on the right side of the respective input fields, the present invention is not limited to this example as long as the setting buttons are displayed so as to correspond to the respective input fields.

As described above, the display size modes of the respective input fields and the display sizes of the input fields set to the respective display size modes are included in the display size setting table 13a. The sizes of the respective input fields 251 to 253 are determined based on the display sizes included in this display size setting table 13a. Moreover, the input screen 200a is generated in the sizes of the determined sizes of the respective input fields 251 to 253.

In this way, when the setting mode of the input field is equivalent to the “automatic mode”, the size of the input field is rendered variable based on the move of the focus automatically. On the other hand, the size of the input field is fixed when the setting mode of the input field is equivalent to the “fixed enlarged mode” or the “fixed reduced mode”.

(Input Screen Display Processing and Input Field Display Change Processing Related to Display Size Mode Change)

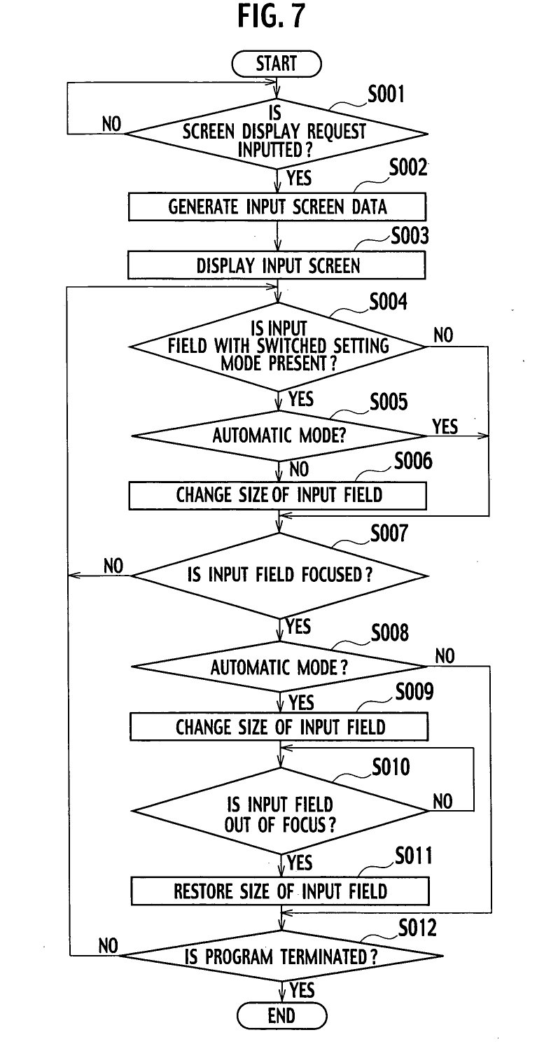

FIG. 7 is a flowchart for explaining display processing to cause the information processing device 1 according to the embodiment of the present invention to display the input screen by an operation of the operator.

FIG. 7 describes an example in which the input field 251 representing the “inquiry content” shown in FIG. 6 is set to the “fixed enlarged mode” and the input fields 252 and 253 representing the “response content” and the “remarks”, respectively, are set to the “automatic mode”.

The primary screen data generation unit 15 of the information processing device 1 stands by for detection as to whether or not a screen display request is inputted from the input unit 14 through the input device 104 such as a mouse manipulated by the operator (S001). Upon receipt of the screen display request from the input unit 14, the primary screen data generation unit 15 reads the input screen information out of the input screen information storage unit 11 and reads the input screen information out of the working memory 13. Then, the primary screen data generation unit 15 generates the primary input screen data based on the display request received in Step S001 (S002). Meanwhile, the primary screen data generation unit 15 reads the input screen information out of the input screen information storage unit 11, and stores the maximum display sizes, the minimum display sizes, and the initial display size modes of the respective input fields included in the input screen information thus read out into the display size setting table 13a in the working memory 13.

The input screen display unit 18 displays the input screen 200a based on the primary input screen data generated by the primary screen data generation unit 15 on the display device 105 (S003).

When the input screen 200a is displayed on the display device 105 and the data input is started by the operator, the secondary screen data generation unit 16 stands by for detection as to whether or not the display size mode of any of the input fields is switched. (S004). To be more precise, on the input screen 200a, the secondary screen data generation unit 16 stands by for any operation of the automatic mode setting buttons 254a to 254c, the fixed enlarged mode setting buttons 255a to 255c, and the fixed reduced mode setting buttons 256a to 256c by the input device 104. When the secondary screen data generation unit 16 detects that the display size mode of any of the input fields is switched, the secondary screen data generation unit 16 rewrites the display size mode in the display size setting table 13a into the switched display size mode.

When there is the input field of which the display size mode is switched, the secondary screen data generation unit 16 refers the display size setting table 13a, and stands by for detection as to whether or not the switched input field is switched to the automatic mode (S005). Here, when the display size mode of the input field is switched to the “fixed enlarged mode” or the “fixed reduced mode” by the input device 104 (NO in S005), the display size mode in the display size setting table 13a is changed into the switched display size mode, and the display size of the input field is changed in response to the changed display size mode (S006).

To be more precise, when the “fixed enlarged mode” is selected, the secondary screen data generation unit 16 changes the display size mode in the display size setting table 13a into the “fixed enlarged mode”, and changes the display size of the input field on the input screen into the maximum display size. On the other hand, when the “fixed reduced mode” is selected, the secondary screen data generation unit 16 changes the display size mode in the display size setting table 13a into the “fixed reduced mode”, and changes the display size of the input field on the input screen into the minimum display size.

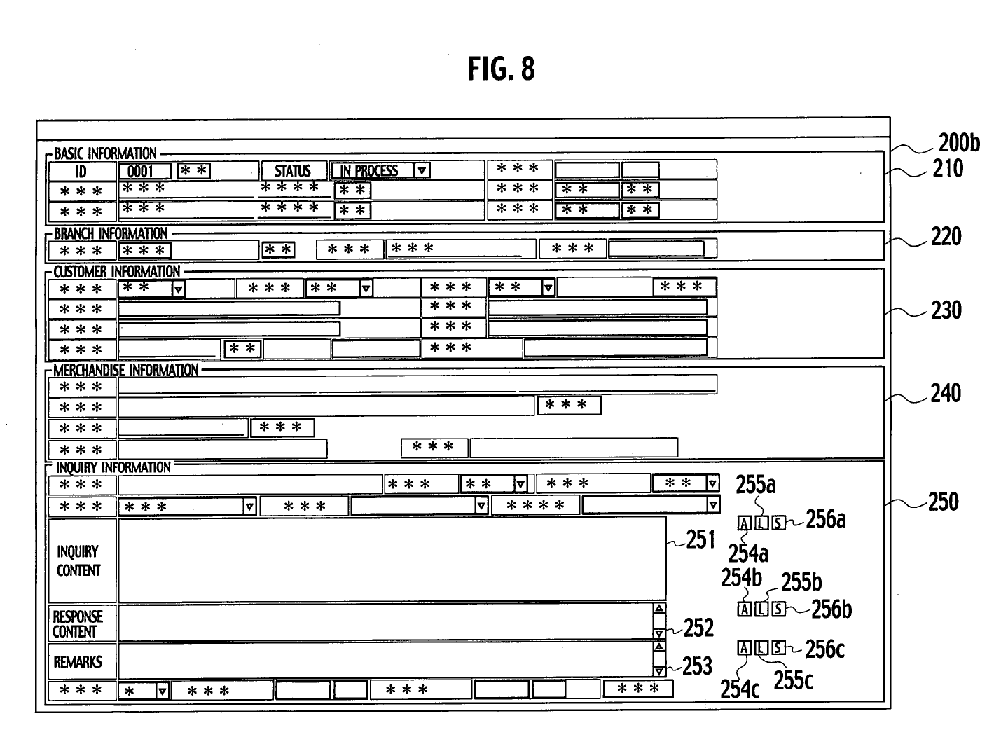

FIG. 8 shows an example of an input screen 200b in the information processing device 1 according to the embodiment of the present invention, in which the input field 251 representing the “inquiry content” is set to the “fixed enlarged mode” and the input fields 252 and 253 representing the “response content” and the “remarks” are set to the “automatic mode”. When the input field 251 for the “inquiry content” on the input screen 200a is set to the “fixed enlarged mode” in Step S006, the input field 251 for the “inquiry content” shown in FIG. 6 is changed into the maximum display size as shown in the input field for the “inquiry content” on the input screen 200b in FIG. 8.

In this case, concerning the setting modes in the display size setting table 13a, the “inquiry input field” is set to the “fixed enlarged mode”, the “response content input field” is set to the “automatic mode”, and the “remarks input field” is set to the “automatic mode” as shown in FIG. 5.

Subsequently, the secondary screen data generation unit 16 stands by for detection as to whether or not any of the input fields on the input screen 200b is focused (S007). Moreover, when there is not input field of which the display size mode is switched in Step S004 or when the mode switched in Step S005 is the automatic mode, the secondary screen data generation unit 16 stands by for detection of the focused input field similarly. Here, when no input field is focused in Step S007, the processing returns to Step S004.

When any of the input fields is focused in Step S007, the secondary screen data generation unit 16 stands by for detection as to whether or not the focused input field is set to the “automatic mode” (S008). Here, when the focused input field is set to the “automatic mode”(YES in S008), the secondary screen data generation unit 16 changed the input field from the minimum display size as set in the display size setting table 13a to the maximum display size (S009).

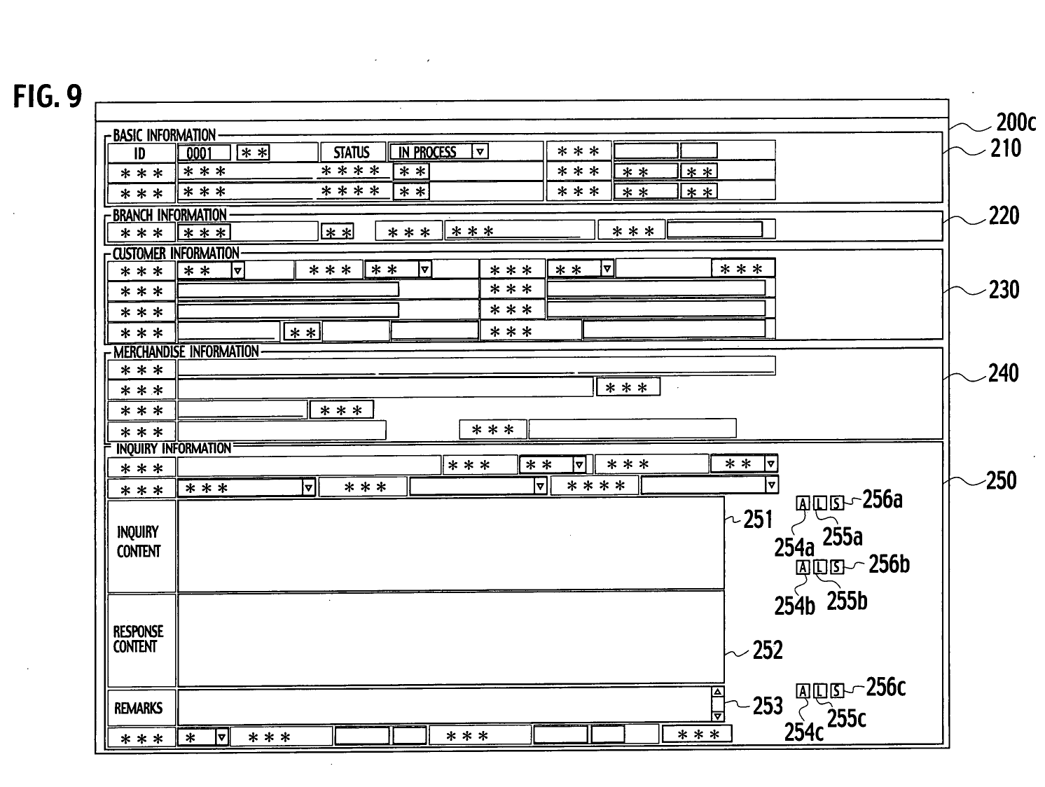

FIG. 9 shows an example of an input screen 200c in the information processing device 1 according to the embodiment of the present invention, in which the input field 252 representing the “response content” is focused when the “response content input field” is set to the “automatic mode” in the display size setting table 13a. When the input field 252 for the “response content” on the input screen 200b which is set to the “automatic mode” is focused in Step S005, the secondary screen data generation unit 16 reads the display size setting table 13a and changes the display size of the input field 252 from the minimum display size to the maximum display size in Step S009 as shown in FIG. 9. The example shown in FIG. 5 including a shade in the display size setting table 13a shows an aspect of focusing on the response content input field having the “input field ID” equivalent to “A002” in a case where the input display 200c is displayed.

Thereafter, the screen display size restoration unit 17 stands by for detection as to whether or not the input field having the display size changed in Step S006 due to the setting of the “automatic mode” is out of focus (S010). When the input field is detected to be out of focus, the screen display size restoration unit 17 reads the display size setting table 13a out of the working memory 13 and restores the display size of the input field out of focus from the maximum display size to the minimum display size (S011).

The processing ranging from Steps S003 to S011 described above is repeated until the program is terminated by the input unit 14 (S012).

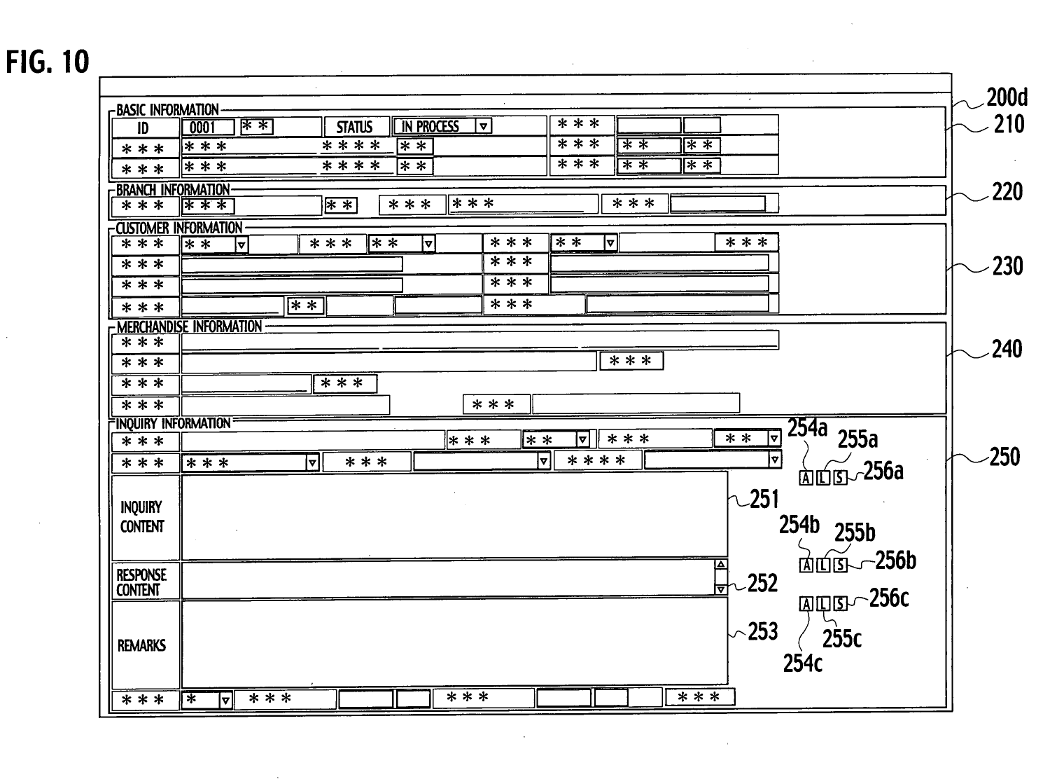

Accordingly, when the focus moves from the input field 252 for the “response content” set to the “automatic mode” to the input field 253 for the “remarks” set to the “automatic mode”, for example, the display size of the input field 252 for the “response content” is changed from the maximum display size to the minimum display size in Step S011, and the display size of the input field 253 for the “remarks” is changed simultaneously in Step S009 from the minimum display size to the maximum display size as shown in an input screen 200d of FIG. 10.

As described above, according to the information processing device of the embodiment of the present invention, while the input field is set to the “automatic mode”, the information processing device controls to change the size of the input field automatically when focus onto each input field on the input screen. And then, the information processing device restores the display size of the input field to the original size when the focus moves to a different input field.

Moreover, the display size of the input field is automatically enlarged at the time of data input by performing the above-described control. In this way, it is possible to input the data while confirming the entire data to be written in the input field while avoiding the data from being hidden by a scrolling operation.

In addition, it is also possible to fix the display size of the input field for reference in the enlarged size by setting the “fixed enlarged mode”. Accordingly, the display size of the input field can be easily enlarged.

### FIRST MODIFIED EXAMPLE

When the display size mode of any of the input fields on the input screen is not set to the “automatic mode”, the above-described embodiment is configured to change the display size of the input field by use of the “fixed enlarged mode” to set the display size to the fixed maximum display size or the “fixed reduced mode” to set the display size to the fixed minimum display size. However, it is also possible to improve operating efficiency by allowing the operator to set the display size of the input field not only to the maximum display size and the minimum display size to be defined in advance, but also to a variable display size.

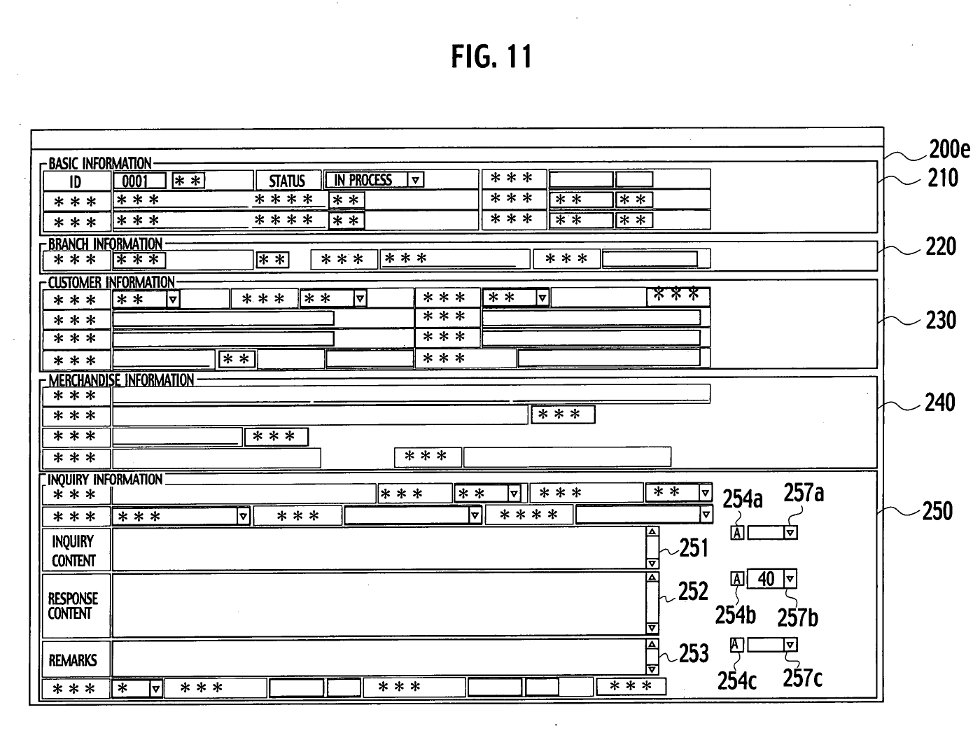

To be more precise, as shown in an input screen 200e of FIG. 11, for example, the respective input fields are provided with size change fields 257a to 257c. The operator can arbitrarily change the display size of the input fields by setting values of the size change fields 257a to 257c.

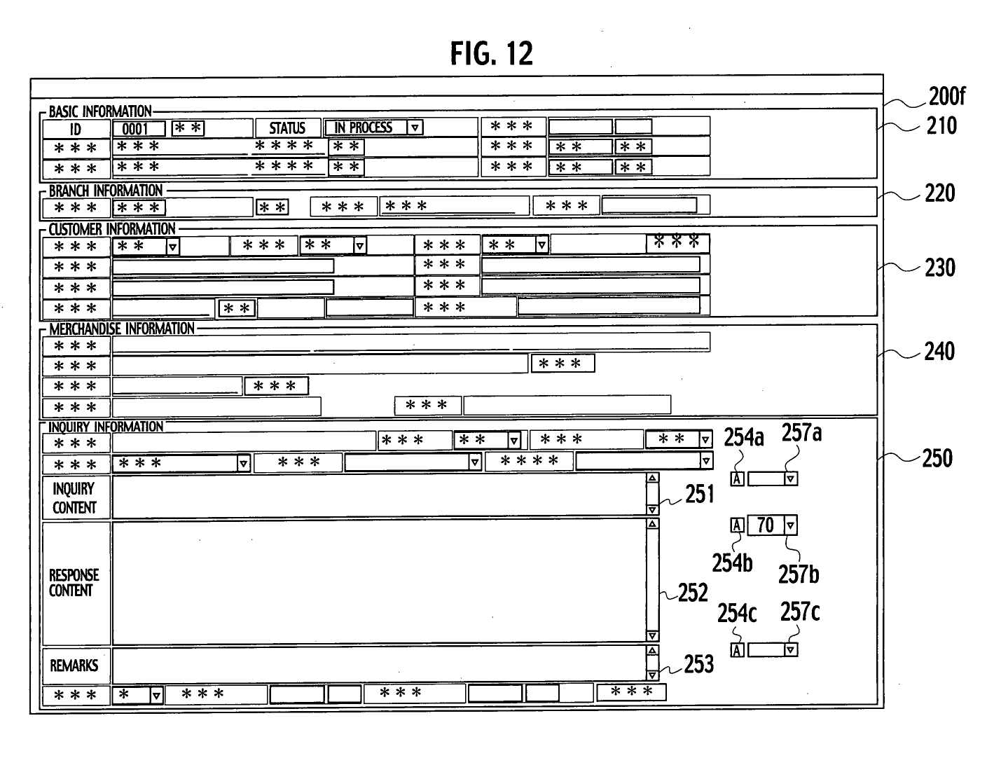

On the input screen 200e of FIG. 11, the display size of the input field 252 for the “response content” is set to “40” in the size change field 257b. When the display size of the input field 252 for the “response content” is set to “70” in the size change field 257b, the input field 252 on an input screen 200f is enlarged as shown in FIG. 12.

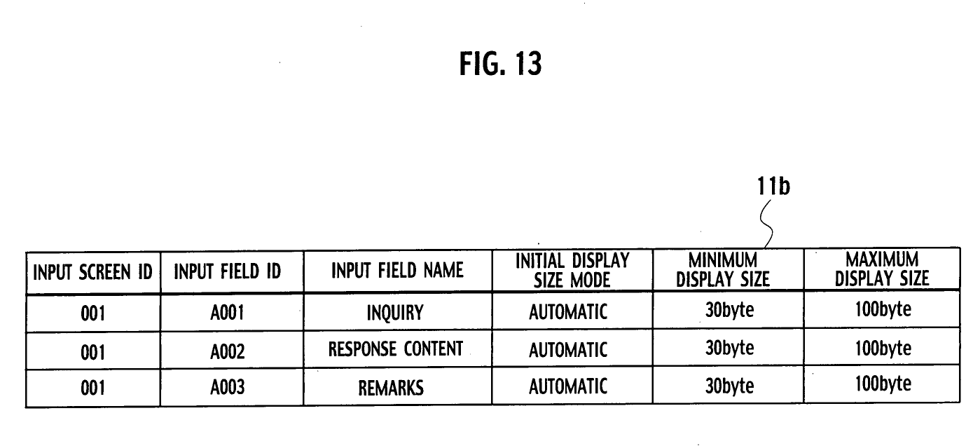

As shown in FIG. 13, the input screen information storage unit 11 according to this modified example stores input screen information 11b including the “initial display size mode”, the “minimum display size”, and the “maximum display size”, which are correlated with the input field ID.

Here, the “maximum display size” defines the maximum display size when changing the display size of the input field. Meanwhile, the “minimum display size” defines the minimum display size when changing the display size of the input field. When changing the display size of the input field, the display size is set to a value between the “maximum display size” and the “minimum display size”. Alternatively, it is also possible to allow the operator to change the “maximum display size” and the “minimum display size” fundamentally.

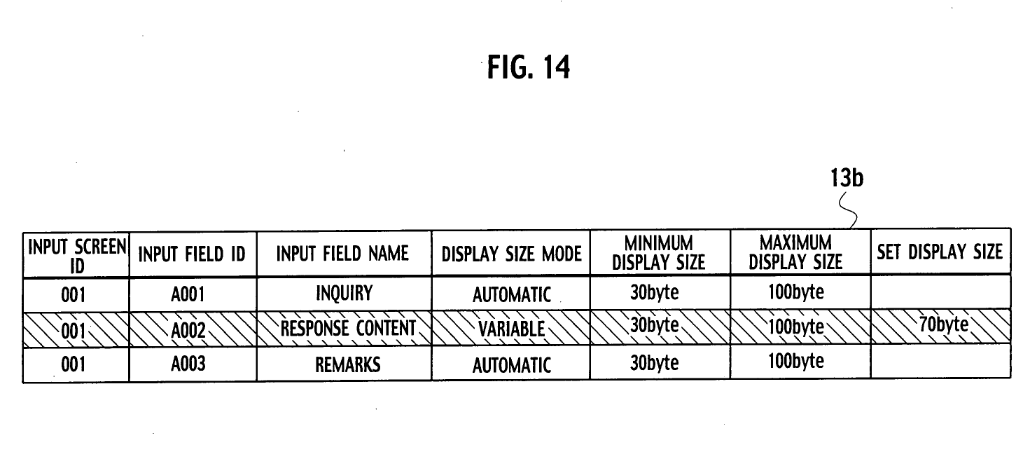

Moreover, according to the information processing device 1 of the first modified example, the working memory 13 stores a display size setting table 13b shown in FIG. 14, for example, instead of the above-described display size setting table 13a shown in FIG. 5. The display size setting table 13b is different from the display size setting table 13a in that the display size setting table 13b is configured to store a “set display size”. In the display size setting table 13b shown in FIG. 14, a display size set to a “variable mode” is stored as the “set display size”.

When the input field is set to the variable mode, the “display size mode” in the display size setting table 13b is rewritten into “variable” as shown in FIG. 14. Meanwhile, when a display size is selected by the operator at a value between the “minimum display size” and the “maximum display size”, the selected display size is stored in the display size setting table 13b as the set display size.

As described above, by allowing the operator to set the display size of the input field arbitrarily, it is possible to display necessary information more efficiently.

### SECOND MODIFIED EXAMPLE

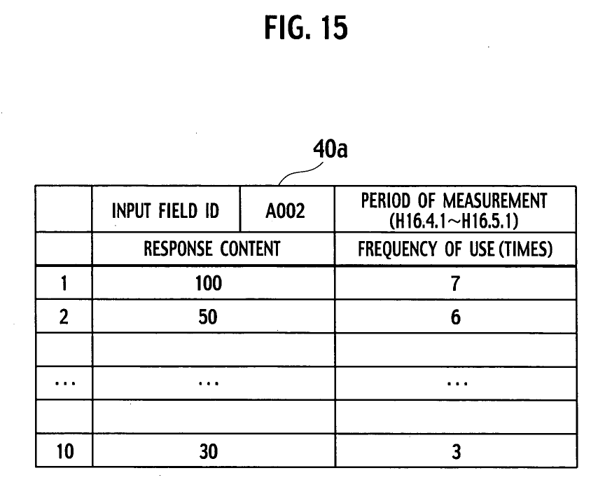

Meanwhile, it is also possible to allow the operator to change display size of the input field by designating a display size from a plurality of candidates of the display sizes for the input field either registered in advance or accumulated depending on the frequency of use. For example, as shown in FIG. 15, the information processing device 1 according to the second modified example is configured to accumulate a history table 40a for the display sizes and to allow the operator to select the display size by use of the display sizes stored as the history. In an example of the history table 40a shown in FIG. 15, the display sizes used in the previous 10 operations, for instance, are stored as the history of the display sizes recently designated for the response content input field. In this case, when the operator intends to change the display size of the response content input field, it is also possible to configure the history table 40a to display the display sizes in the descending order of the frequency used in the previous 10 operations. In the example shown in FIG. 15, the most frequently used display size is equivalent to 100 bytes used 7 times. Accordingly, the history table displays in the descending order from 100 bytes, for example.

In this way, it is possible to display the display sizes in the descending order of the frequency of selection, and thereby to allow the operator to perform selection easily.

### THIRD MODIFIED EXAMPLE

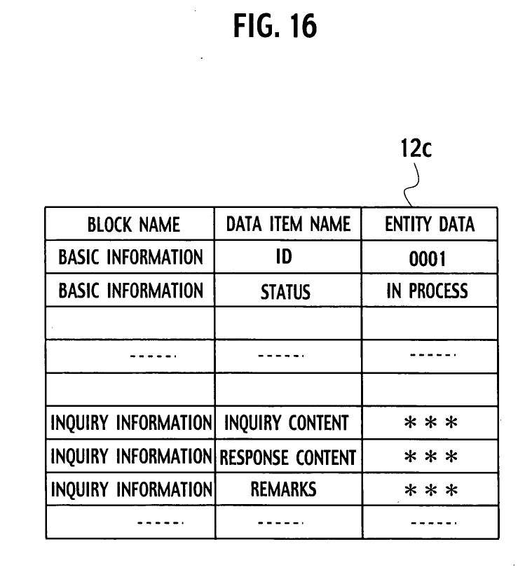

Meanwhile, according to the embodiment and the modified examples described above, the size of the input field is set up while using the input field ID correlated with the input field name as the key. However, according to the information processing device 1 of the third modified example, the size of the input field is set up while using a block ID correlated with a block name as a key, for example. In this case, as shown in FIG. 16, the operating memory 13 stores the following entity data as input information 12c, namely, the “inquiry ID” item and the “status” item relative to a block name “basic information”, the “inquiry content” item, the “response content” item, and the “remarks” item relative to a block name “inquiry information”, and so forth.

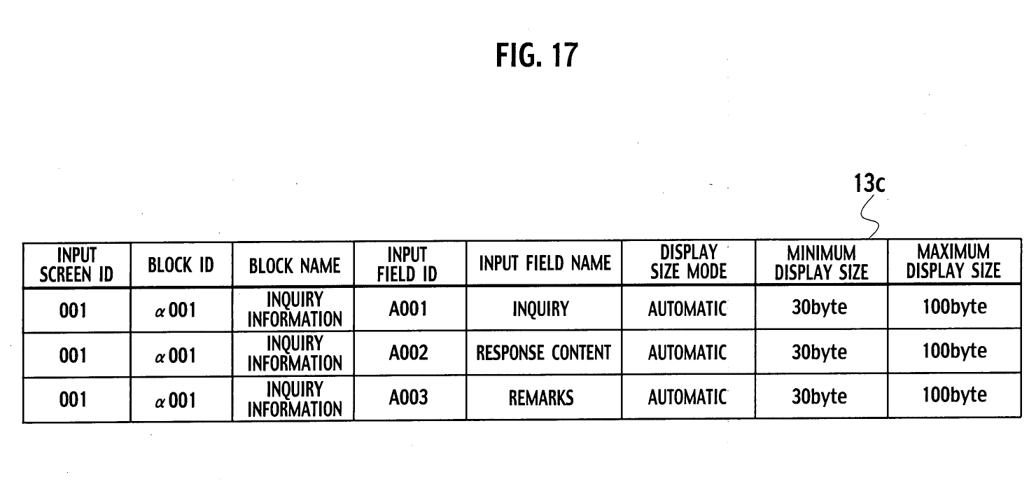

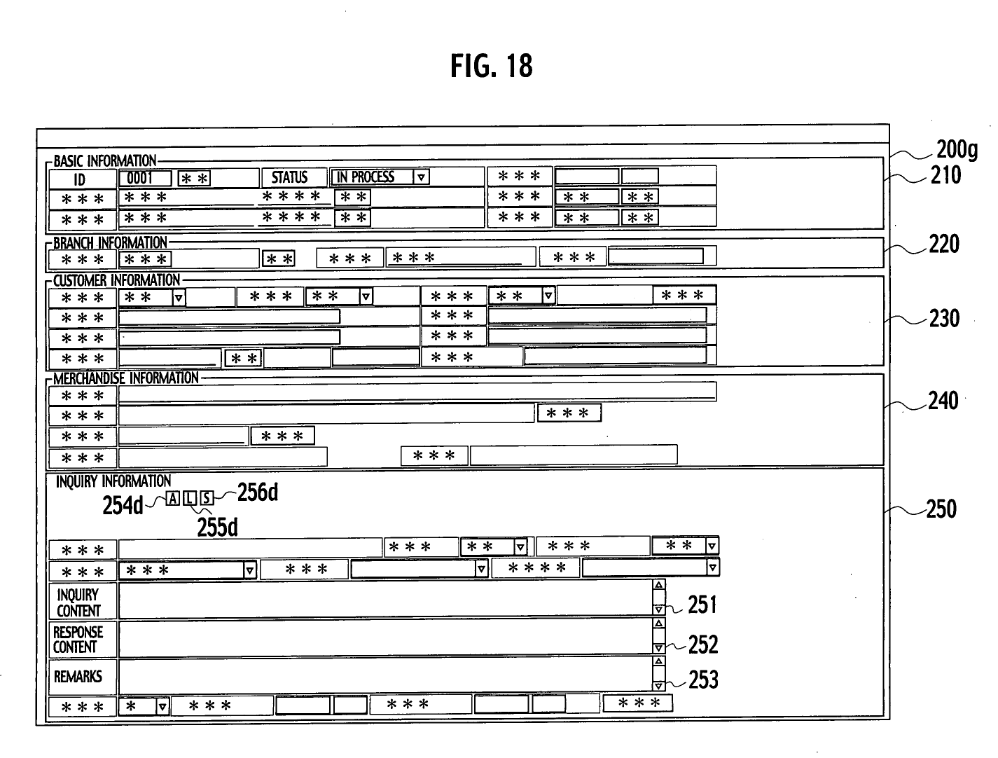

Moreover, the display sizes are set up based on a display size setting table 13c using the block ID as the key as shown in FIG. 17. In this case, the display size mode buttons are not provided for all the input fields. Instead, as shown in FIG. 18, a set of display size mode buttons including an automatic mode setting button 254d, a fixed enlarged mode setting button 255d, and a fixed reduced mode setting button 256d are only provided in terms of each block (e.g., the basic information, the branch information, the customer information, . . . , the inquiry information) on the input screen. The sizes of all the input fields belonging to the block 250 for the “inquiry information” are changed by operating the setting buttons 254d to 256d. For example, when the fixed enlarged mode is set up by operating the fixed enlarged mode button 255d, the maximum display size is applied to all the input fields 251 to 253 displayed inside the block “inquiry information”, and the respective input fields are therefore displayed in the maximum display size. On the other hand, when the fixed reduced mode is set up by operating the fixed reduced mode button 256d, the minimum display size is applied to all the input fields 251 to 253 displayed inside the block “inquiry information”, and the respective input fields are therefore displayed in the minimum display size. Meanwhile, when the automatic mode is set to all the input fields 251 to 253 displayed inside the block “inquiry information” by operating the automatic mode button 254d, the maximum display size is applied to the input field focused by the operation of the operator and the focused input field is therefore displayed in the maximum display size. When the input field applying the maximum display size becomes out of focus, the minimum display size is applied thereto and the input field is therefore displayed in the minimum display size.

### FOURTH MODIFIED EXAMPLE

Meanwhile, according to the above-described third modified example, all the input fields located in the same block are operated by the common setting buttons. To be more precise, all the input fields 251 to 253 belonging to the block 250 for the “inquiry information” are operated by the setting buttons 254d to 256d. Alternatively, it is also possible to provide a unique button to a certain input field out of the plurality of input fields.

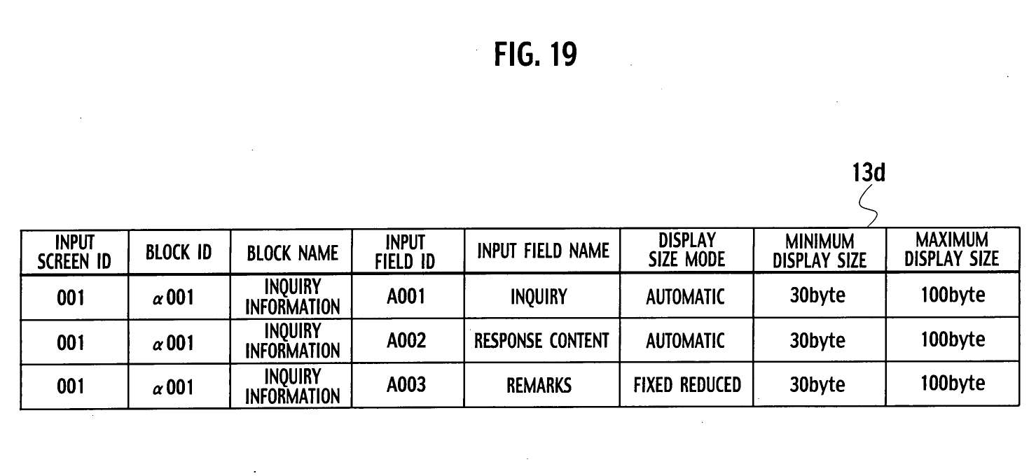

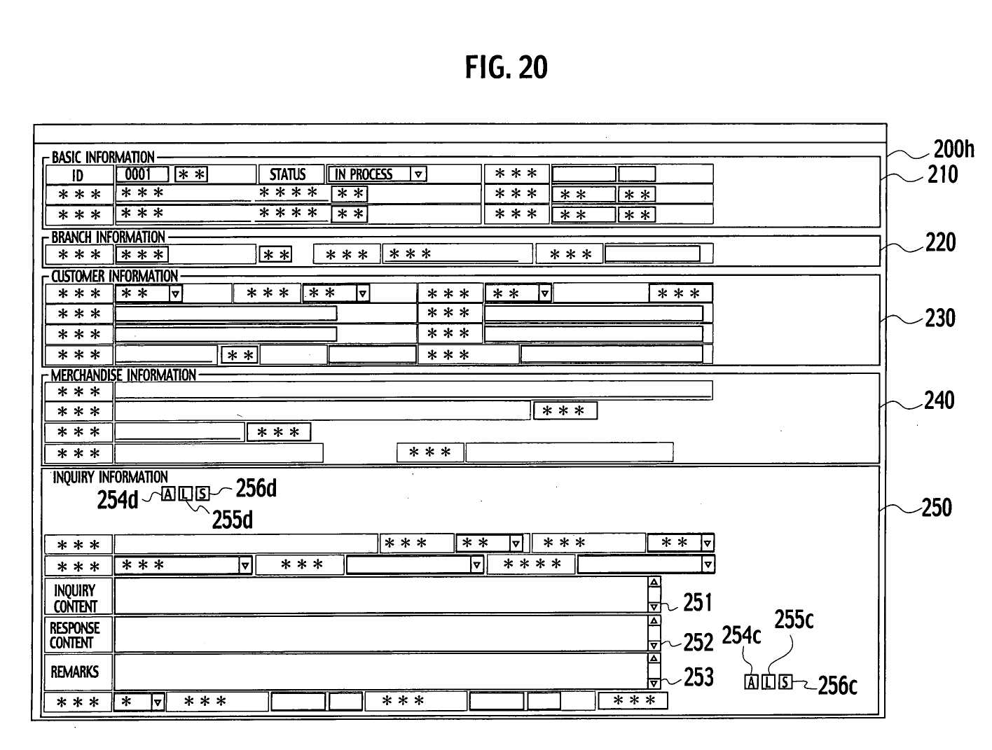

For example, an assumption is made here that the input field 253 for the “remarks” is used less frequently. Now, if all the input fields 251 to 253 inside the block 250 for the “inquiry information” are set to the fixed enlarged mode by operating the fixed enlarged mode setting button 255d, the input field for the “remarks”, which is thought to be used less frequently, is displayed in the maximum display size together with other input fields. In such a case, an input screen 200g extends vertically and becomes partially invisible when displayed on the display device and the like. As a result, this aspect may obstruct the input operation. For this reason, it is possible to facilitate the operation by setting only the input field for the “remarks” to the fixed reduced mode as shown in FIG. 19. Therefore, according to the fourth modified example, only the input field 253 for the “remarks” is provided with setting buttons 254c to 256c as shown in an input screen 200h of FIG. 20.

The present invention has been described above by the embodiment and the modified examples. However, it is to be understood that the present invention shall not be limited to the descriptions and drawings constituting part of this disclosure. It is obvious to those skilled in the art that various other embodiments, examples, and operation techniques are possible from the teachings of this disclosure.

For example, the embodiment of the present invention is configured to store the various data in the storage device 107. Notwithstanding the foregoing, the present invention may be also configured to store the various data temporarily in the RAM 103 instead of storing the data in the storage device 107, for example.

It is needless to say that the present invention may also include various other embodiments and examples not expressly stated herein. Therefore, the technical scope of the present invention shall be solely defined by the issues described in the foregoing explanations and by matters to define the invention which become apparent as defined in the appended claims.

What is claimed is:

1. An information processing device configured to store data in a storage device and to display an input screen for inputting data on a display device, based on instructions from an input device, the information processing device comprising:
input screen information storing unit which stores input screen information correlate at least an input field identifier to identify each input field on the input screen to be displayed on the display device and a first display size and a second display size being character display limit values for the input field specified by the input field identifier;
primary screen data generating unit which generates input screen data based on the input screen information corresponding to a display instruction by the input device and allocating the first display size included in the input screen information to the character display limit value of each input field;
secondary screen data generating unit which generates input screen data, when an arbitrary input field on the input screen displayed on the display device is focused, based on an instruction from the input device, by changing the character display limit value corresponding to the input field identifier of the focused input field from the first display size into the second display size; and
input screen displaying unit which displays an input screen, based on the generated input screen data on the display device.

2. An information processing device according to claim 1,
wherein the primary screen data generating unit which generates input screen data for displaying a link with a display size mode setting unit to select any one of display size modes from an automatic mode, a fixed enlarged mode, and fixed reduced mode as a display size mode of the input field having the first display size;
wherein the secondary screen data generating unit which generates input screen data, when an arbitrary input field on the input screen of which the display size mode of the input field subject to allocation of the first display size is set to the automatic mode is focused, based on an instruction from the input device, by changing the character display limit value corresponding to the input field identifier of the focused input field from the first display size into the second display size.

3. The information processing device according to claim 2,
wherein the secondary screen data generating unit generates the input screen data by changing the character display limit value of the input field to a predetermined maximum display size, when the display size mode of the input field to which the first display size is allocated is set to the fixed enlarged mode based on the instruction from the input device.

4. The information processing device according to claim 2,
wherein the secondary screen data generating unit generates the input screen data by changing the character display limit value of the input field to a predetermined minimum display size when the display size mode of the input field to which the first display size is allocated is set to the fixed reduced mode based on the instruction from the input device.

5. The information processing device according to claim 1, further comprising:
screen size restoring unit which generates input screen data, when the input field on the input screen, based on the input screen data generated by the secondary screen data generating unit becomes out of focus, by changing the character display limit value corresponding to the input field identifier from the second display size to the first display size.

6. The information processing device according to claim 2, further comprising:
screen size restoring unit which generates input screen data, when the input field on the input screen, based on the input screen data generated by the secondary screen data generating unit becomes out of focus and when the input field is set to the automatic mode by the display size mode setting unit, by changing the character display limit value corresponding to the input field identifier from the second display size to the first display size.

7. An information processing device configured to store data in a storage device and to display an input screen for inputting data on a display device, based on instructions from an input device, the information processing device comprising:
input screen information storing unit which stores input screen information correlate at least a block identifier to identify a block for a group linking input fields of an input screen to be displayed on the display device, with an input field identifier for identifying each input field in the block specified by the block identifier, and with a first display size and a second display size being character display limit values for each input field specified by the block identifier;
primary screen data generating unit which generates input screen data allocating the first display size included in the input screen information to the character display limit value of each input field, based on the input screen information subject to a display instruction for display the input screen by the input device;
secondary screen data generating unit which generates input screen data, when an arbitrary input field on the input screen displayed on the display device is focused, based on an instruction from the input device, by changing the character display limit value corresponding to the input field identifier of the focused input field from the first display size into the second display size; and
input screen displaying unit which displays an input screen based on the generated input screen data on the display device.

8. An information processing device according to claim 7,
wherein primary screen data generating unit for and generating input screen data for displaying a link with a display size mode setting unit to select any one of display size modes from an automatic mode, a fixed enlarged mode, and fixed reduced mode as a display size mode of each input field in the block specified by the block identifier;
wherein secondary screen data generating unit which generates input screen data, when an arbitrary block on the input screen of which the display size mode of each input field in the block subject to allocation of the first display size is set to the automatic mode is focused based on an instruction from the input device, by changing the character display limit value of each input field corresponding to the block identifier for identifying the focused block from the first display size into the second display size.

9. The information processing device according to claim 8,
wherein the secondary screen data generating unit generates the input screen data by changing the character display limit value of each input field corresponding to the block to a predetermined maximum display size, when the display size mode of each input field in the block to which the first display size is allocated is set to the fixed enlarged mode based on the instruction from the input device.

10. The information processing device according to claim 8,
wherein the secondary screen data generating unit generates the input screen data by changing the character display limit value of each input field corresponding to the block to a predetermined minimum display size, when the display size mode of each input field in the block to which the first display size is allocated is set to the fixed reduced mode based on the instruction from the input device.

11. The information processing device according to claim 7, further comprising:
screen size restoring unit which generates input screen data, when the block on the input screen based on the input screen data generated by the secondary screen data generating unit becomes out of focus, by changing the character display limit value of each input field in the block from the second display size to the first display size.

12. The information processing device according to claim 8, further comprising:
screen size restoring unit which generates input screen data, when the block on the input screen, based on the input screen data generated by the secondary screen data generating unit becomes out of focus and when the block is set to the automatic mode by the display size mode setting unit, by changing the character display limit value of each input field in the block from the second display size to the first display size.

13. A computer program product configured to instruct a computer to store data in a storage device and to display an input screen for inputting data on a display device, based on instructions from an input device, the program causing the computer to execute the steps of:
referring input screen information storing in a input screen information storing unit, corresponding to the input screen to display in instructions by the input device, configured to correlate at least an input screen identifier to identify input screen data of an input screen to be displayed on the display device, with an input field identifier to identify each input field on the input screen specified by the input screen identifier, and with a first display size and a second display size being a character display limit value for the input field specified by the input field identifier, and generating input screen data by allocating the first display size included in the input screen information to the character display limit value of each input field;
generating input screen data when an arbitrary input field on the input screen is focused, based on an instruction from the input device by changing the character display limit value corresponding to the input field identifier of the focused input field from the first display size into the second display size; and
displaying an input screen, based on the generated input screen data on the display device.

14. A computer program product configured to instruct a computer to store data in a storage device and to display an input screen for inputting data on a display device, based on instructions from an input device, the program causing the computer to execute the steps of
generating input screen data by allocating the first display size included in the input screen information to the character display limit value of each input field based on input screen information corresponding to an input screen subject to a display instruction out of input screen information storing unit which stores input screen information configured to correlate at least a block identifier to identify a block for grouping while linking an input screen identifier for identifying input screen data of an input screen to be displayed on the display device with a given input field on the input screen specified by the input screen identifier, with an input field identifier for identifying each input field in the block specified by the block identifier, and with a first display size and a second display size being character display limit values for each input field specified by the block identifier, and;
generating input screen data when an arbitrary input field on the input screen is focused, based on an instruction from the input device by changing the character display limit value corresponding to the input field identifier of the focused input field from the first display size into the second display size; and
displaying an input screen, based on the generated input screen data on the display device.
